(19) United States
(12) Patent Application Publication
(10) Pub. No.: US 2013/0155662 A1
(43) Pub. Date: Jun. 20, 2013

(54) Modular Lighting System

(71) Applicant: Eaton Industries (Austria) GmbH, Schrems (AT)

(72) Inventor: Thomas Göschl, Hirschbach (AT)

(73) Assignee: Eaton Industries (Austria) GmbH, Schrems (AT)

(21) Appl. No.: 13/679,619

(22) Filed: Nov. 16, 2012

Related U.S. Application Data
(60) Provisional application No. 61/560,924, filed on Nov. 17, 2011.

(51) Int. Cl. F21L 2/00; F21L 4/08; F21L 4/00

(52) U.S. Cl. CPC F21L 2/00; F21L 4/00; F21L 4/08
USPC 362/183; 362/249.01; 362/249.02; 362/191

(57) ABSTRACT

A modular lighting system includes a mobile lighting unit and a stationary power supply network connection unit, wherein the lighting unit has at least one light source, wherein the lighting unit and the network connection unit have corresponding electrical contacts for electrical connection of the lighting unit to the network connection unit, wherein the network connection unit has electrical connections to connect the network connection unit to an electrical power supply network, wherein the electrical connections are formed as electrical connection terminals, and wherein the network connection unit has a rail mount for installation on a mounting rail of an electrical distribution system.

The invention relates to a modular lighting system according to the preamble of patent claim 1.

There are known modular lighting systems which consist of a portable lamp as well as an AC adapter that is usually permanently connected to the network. Such network adapters are designed, for example, as a plug-in adapter for use with a conventional power supply socket. The system is so designed that the portable lamp is installed in a housing of the AC adapter and is charged by a battery inside the portable lamp. If necessary, the portable lamp can be removed from the AC adapter and can be used as a conventional flashlight.

A disadvantage of such known modular lighting systems is that they constantly occupy a power supply socket. A further disadvantage is that they—if present—can only be found by a local guide light and, consequently, in the event of a power failure and the darkness necessarily associated with this, they can often not be used as they simply cannot be found. In addition, such lamps encounter considerable resistance from the market and hence have a correspondingly low distribution as they are only partially compatible with today's existing notions of interior design and so, in the event of a night-time power outage, many people still rely on candles as in former times, with the resultant danger of injury and fire.

The object of the invention is therefore to provide a modular lighting system of the type mentioned where the disadvantages mentioned can be avoided, where a simple detectable mobile emergency illumination can be provided, and where the system has a high level of acceptance by the user.

In terms of the invention, this is achieved with the features of patent claim 1.

Thus, an easy-to-find mobile emergency lighting is provided. The integral rail mount of the modular lighting system enables it to be installed in the local distribution cabinet, also referred to as the fuse box. Thus, the lighting unit is easy to find. In particular, the lighting unit is located exactly where even people unfamiliar with the premises expect to troubleshoot in the event of a power failure, leading to the high probability of the modular lighting system being found. In addition, by installation in the distribution cabinet, the lighting unit is not in constant view in a home, thus encouraging a high level of acceptance by the user. This further reduces the risk of fire and/or injury in the event of a power outage while facilitating rapid troubleshooting.

The dependent claims relate to further advantageous embodiments of the invention.

Reference to the wording of the claims is expressly made here, whereby the claims are included at this point by reference in the description and are reproduced word for word.

With reference to the enclosed drawings, which merely show a preferred embodiment in an exemplary manner, the invention is described in more detail. With:

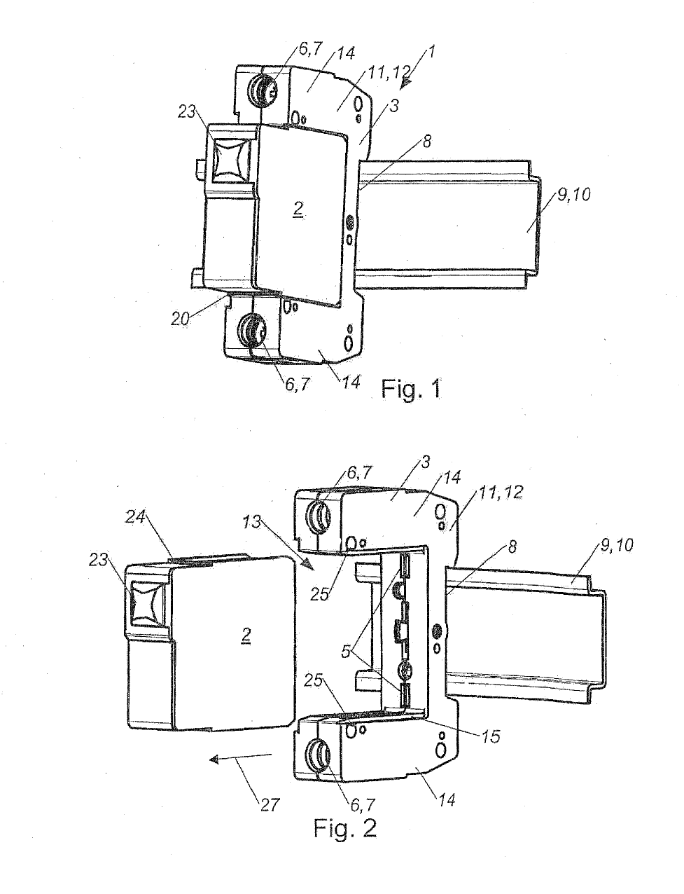

FIG. 1 shows a preferred embodiment of a modular lighting system in the assembled state that is arranged on a mounting rail in an axonometric view;

FIG. 2 shows the modular lighting system according to FIG. 1 with the lighting unit separated from the power supply network connection unit in an axonometric view;

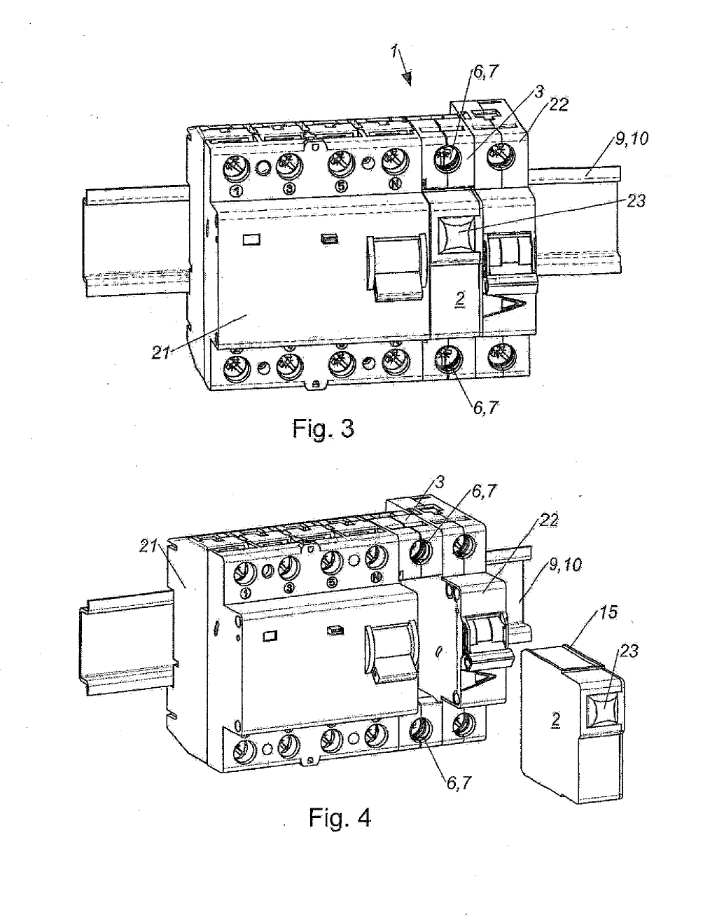

FIG. 3 shows the modular lighting system according to FIG. 1 installed in proximity to two switching devices on a common mounting rail in an axonometric view;

FIG. 4 shows the arrangement according to FIG. 3 with the lighting unit separated from the power supply network connection unit in an axonometric view;

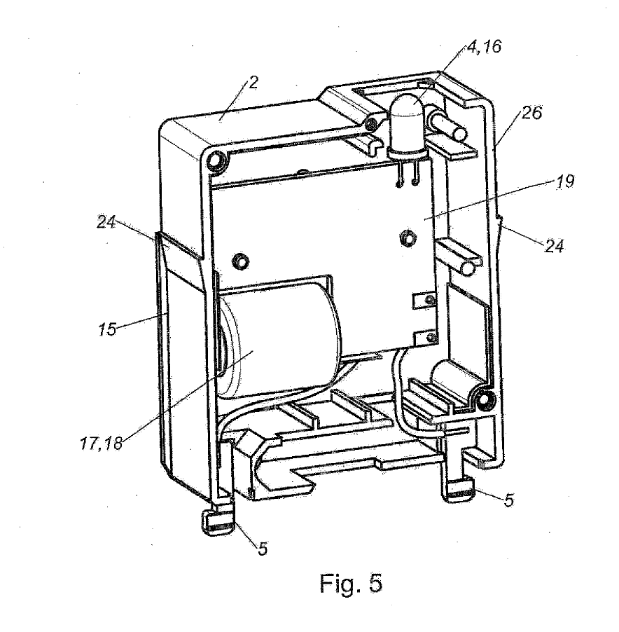

FIG. 5 shows an interior view of a preferred embodiment of a lighting unit according to FIGS. 1 to 4.

FIGS. 1 to 4 show a preferred embodiment of a modular lighting system 1 comprising a mobile lighting unit 2 and a stationary power supply network connection unit 3, whereby the lighting unit 2 has least one light source (4), whereby the lighting unit 2 and the network connection unit 3 have corresponding electrical connector plug-in contacts 5 for electrical connection of the lighting unit 2 to the network connection unit 3, whereby the network connection unit 3 has electrical connections 6 to connect the network connection unit 3 to an electrical power supply network, whereby the electrical connections 6 are formed as electrical connection terminals 7, and whereby the network connection unit 3 has a rail mount 8 for installation on a mounting rail 9 of an electrical distribution system.

Thus, an easy-to-find mobile emergency lighting is provided. The integral rail mount 8 of the modular lighting system 1 enables it to be installed in the local distribution cabinet, also referred to as the fuse box. Thus, the lighting unit 2 is easy to find. In particular, the lighting unit 2 is located exactly where even people unfamiliar with the premises expect to troubleshoot in the event of a power failure, leading to the high probability of the modular lighting system 1 being found. In addition, by installation in the distribution cabinet, the lighting unit is not in constant view in a home, thus encouraging a high level of acceptance by the user. This further reduces the risk of fire and/or injury in the event of a power outage while facilitating rapid troubleshooting.

The modular lighting system 1 represented comprises at least two parts, a stationary network connection unit 3 as well as a mobile lighting unit 2. It may be arranged for further components to be part of the modular lighting system 1, such as additional mobile lighting units 2 that can be arranged approximately parallel in a correspondingly wider network connection unit 3. In particular, it is provided that the modular lighting system 1 consists of exactly one stationary network connection unit 3 and a mobile lighting unit 2. The mobile lighting unit 2 is referred to hereinafter simply as lighting unit 2. The stationary network connection unit 3 is also referred to hereinafter simply as network connection unit 3.

It is preferably provided that the modular lighting system 1 is placed in an electrical distribution box, switching cabinet, or fuse box.

The mobile lighting unit 2 is designed at least as a temporary stand-alone and portable lamp, roughly comparable to the function of a flashlight.

The network connection unit 3 has the function of a charging station or a storage point for the lighting unit.

It is provided that, in a normal case, the lighting unit 2 is disposed in or on the network connection unit 3, and is in electrical contact with the latter. This enables an energy storage device 17 inside the lighting unit 3 to be charged as needed.

It is provided that the lighting unit 2 and the network connection unit 3 work together in the manner of a plug and socket. Accordingly, the network connection unit 3 has a receptacle 13 for the lighting unit 2 and that is designed to accept only the specific lighting unit 2.

The two preferred individual components of the modular lighting system 1 are described below, beginning with the network connection unit 3, subsequently the lighting unit 2 will be described, as well as the specifics of the interaction of the two components.

The network connection unit 3 comprises six electrical connections for connection of the network connection unit 3 to an electric power supply network, such as the European-240V power supply. It is provided that the electrical connections 6 are formed as electrical terminals 7. The electrical connection terminals 7 enable direct connection of electrical conductors in the cable or mounting rail to the network connection unit 3. Preferably, the connection terminals 7 are designed as screw terminals or plug-in terminals.

The network connection unit 3 has two receptacles. A receptacle 13 for the lighting unit 2, as well as a second receptacle for mounting the network connecting unit 3 itself. It is provided that the network connection unit 3 has a rail mount 8 for installation of the network connection unit 3 on a mounting rail 9 of an electrical distribution system. This allows the network connection unit 3, respectively the modular lighting system 1, to be installed simply and without difficulty in an electrical distribution system, such as in a switching cabinet or fuse box.

In this context, it is provided in particular that the rail mount 8 also has corresponding locking systems, such as movable tabs, locking slides and/or spring-loaded slides that are used to fix the network connection unit 3 on the mounting rail 9 as well as to allow removal. The corresponding parts are not shown in the figures. It is preferably provided that the rail mount 8 is formed similarly to a corresponding rail mount 8 of an electric circuit breaker. FIGS. 3 and 4 respectively show an arrangement of a residual current circuit breaker 21, a modular lighting system 1 according to the invention and a circuit breaker 22, which are arranged together on the same mounting rail 9, which is designed as a top hat rail 10.

It is preferably provided that the rail mount 8 is designed to be installed on a top hat mounting rail 10 and/or a G-rail, and/or a C-rail. FIGS. 1 through 4 show network connection units 3, which are arranged on a top hat rail 10.

Preferably it is provided that the network connection unit 3 is formed as a plug-in socket 11. This permits simple removal of the lighting unit 2 when required. The term plug-in socket 11 refers to the ability of the lighting unit 2 to be plugged in. Therefore also to the absence of other separate disassembly means that could delay the removal process.

in this context, it is preferably provided that the network connection unit 3 has a U-shaped base body 12 having a receptacle 13 for the lighting unit 2. Preferably, it is provided that at least one guide slot 15 is arranged in the legs 14 of the U-shaped base body 12. This ensures secure retention of the lighting unit 2.

As can be seen in FIG. 2, the electric plug contacts 5 are arranged on a web of the U-shaped base body 12 for electrical connection of the lighting unit 2 to the network connection unit 3. The respective electrical plug-in contacts 5 are in the form of female plug-in contacts in the preferred embodiment.

To prevent accidental removal of the lighting unit 2 from the network connection unit 3, it is preferably provided that the lighting unit 2 is arranged in the network connection unit 3 and connected to the latter via the plug-in contacts 5, as well as being further retained in the network connection unit 3 by a releasable latching connection 20. Corresponding latches on the lighting unit 2 are shown in FIGS. 2, 4 and 5. The corresponding latch recesses 25 are only partially shown in FIG. 2.

According to a particularly preferred embodiment of a network connection unit 3, it may be provided that the latter may be formed in a substantially identical design to the other plug-in sockets, for example to receive a surge arrester, This means that the technical resources required to manufacture the corresponding network connection units 3 are kept low because the production of a suitably independent unit can be omitted. In this way, the need for a separate electro-technical release is also avoided.

The lighting unit 2 comprises a housing 26 which is preferably made from insulating material. The housing 26 has at least partially a shape that matches a corresponding receptacle 13 in the network connection unit 3. It is provided in particular that at least a guide slot 15 and/or guide spring is arranged on the housing 26 and extends in the direction of withdrawal 27. It is provided that a corresponding guide slot 15 and/or guide spring is arranged in the receptacle 13 of the network connection unit 3.

The lighting unit 2 comprises at least a light source 4, which may be any type of electrical component that emits light under pre-determinable operating conditions. In particular, it is provided that the light source 4 is in the form of a light emitting diode LED 16 or OLED. LEDs and OLEDs have advantageous high luminance and high efficiency. This means both high luminosity of the lighting unit 2 as well as a long life of the possible lighting. In addition, the lighting unit 2 only needs to be equipped with a single light source 4.

The lighting unit 2 preferably also has at least one energy storage device 17 for the network-free operation of the lighting unit 2. In particular it is provided that the energy storage device 17 is in the form of an accumulator 18. Alternatively, another electrical energy storage device 17 such as a capacitor may be provided. By means of an accumulator 18, a long operating life can be obtained for a small volume, as well as long life at low cost.

Preferably, the lighting unit 2 is provided with at least control and/or charging electronics 19 to maintain the charging level of the energy storage device 17. It may also be provided, although with limited functionality, that appropriate control and/or charging electronics 19 are located in the power supply network connection unit 3.

The lighting unit 2 has electrical plug-in contacts 5 for electrical connection of the lighting unit 2 to the network connection unit 3. In the preferred embodiment, these contacts project from underneath the housing 26.

In particular, the modular lighting system 1 is to be provided with an illumination element that is reliable and easy-to-find in the event of the failure of the electrical power supply network, commonly called a power outage. According to a preferred embodiment, the control and/or charging electronics 19 are so formed that the illumination element is activated in the event of a loss of power to the lighting source 4. Thus the light source 4 is illuminated automatically if the event of a power failure. This has the advantage that the lighting unit 2 makes its presence and location known autonomously. Even when the modular lighting system 1 is installed in a distribution cabinet, commonly known as a fuse box, the emitted light can shine through gaps. At the latest, on opening the fuse box there is already light available for guidance.

Alternatively, it may be provided that the lighting unit 2 has a switch which is so formed that the light source 4 is activated on removal of the lighting unit 2 from the network connection unit 3. This means that light does not become immediately available in the event of a power failure as the light source 4 is only activated when it is actually needed by a user thus extending the operating life. This has particular advantages, for example, when a user is not at home when a power failure occurs and thus the power failure might not be determined until after a considerable delay.

According to a further preferred embodiment, it may be provided that the modular lighting system 1 has means that are so designed that they activate the light source 4 when the door of the distribution cabinet is opened. This can be achieved by the light source 4 only being activated when one wants to access it. Thus the charged level of the energy storage device 17 is not reduced, and light is still immediately available when the fuse box is opened. In this respect, it may be provided that the modular lighting system 1 has a switch in the area of the corresponding door or has a motion detector.

Moreover it is preferably provided that the lighting unit 2 has a conventional on/off switch, whereby the operation of the lighting unit 2 may be adjusted to the respective conditions. It is preferably provided that the switch in question may also be used to manually deactivate a lighting source 4 that has already been activated automatically.

Preferably, it may also be provided that the above features are combined. It may be provided that the control and/or charging electronics 19 are so designed that the lighting source 4 is activated for a predetermined period of time, about 15 minutes, in the event of a failure of the power supply, and is then deactivated insofar as the lighting unit 2 is not removed from the receptacle 13 within this predetermined period. In such a case, it may be assumed that there is no need, for example because the user is not present. In this case, in preferred embodiment it may be provided that—as mentioned above—that the light source 4 that has already been deactivated can again be activated by opening the door of the fuse box or by the removal of the lighting unit 2 from the receptacle 13.

FIG. 5 shows a particularly preferred embodiment of a lighting unit 2, whereby a part of the housing 26 is not shown in order to allow a view of the interior of the lighting unit 2. The lighting unit 2 has a multi-part housing made of insulating material, whereby the guide slot 15 is provided on one side of the housing, as well as a locking lug 24 as part of a releasable latching connection 20. The lighting unit 2 is plugged into a corresponding receptacle 13 of the network connection unit 3 in the direction of the guide slot 15 and perpendicular to the extension of the locking lug 24.

In the preferred embodiment, the two electrical plug-in contacts 5 of the lighting unit 2 project from underneath the housing 26 and are in the form of male plug-in contacts 5. it is provided that the plug-in contacts 5 are part of the releasable latching connection 20. Recesses can be clearly seen on the two plug-in contacts 5.

Within the housing 26, the plug-in contacts 5 are electrically connected by means of cables to the control and/or charging electronics 19, which are disposed on a circuit board. The light source 4 in the form of an LED 16 is also directly located on the respective printed circuit board. The housing 26 has an opening at the corresponding position with respect to the LED 16 that is covered by a cover 23 in the complete lighting unit 2; the cover is not shown in FIG. 5.

Within the lighting unit 2, there is also an energy storage device 17 in the form of a storage battery 18 that is electrically connected to the control and/or charging electronics 19.

According to an embodiment of the subject of the invention that is not shown, it may be provided that the lighting unit 2 further has a self-retracting cable in the housing 26 that is in particular fixed to a corresponding part arranged outside of the housing 26. It is provided that the length of the cable, preferably made of thin wire, is dimensioned such that the lighting unit 2 can be worn on the forehead when the cable is pulled out. The self-retracting cable enables such a lamp to be fixed firmly to the head of a user or to an object. By means of a corresponding arrangement of the light source 4, a lighting unit 2 can be designed that allows one to work with both hands in an emergency. In this case, all the required mechanics can be installed in the housing 26 so that the above-mentioned functionality can still be provided.

What is claimed is:

1-13. (canceled)

14. A modular lighting system, comprising:
a mobile lighting unit having at least one light source; and
a stationary power supply network connection unit having electrical connections formed as electrical connection terminals for connection of the network connection unit to an electrical power supply network, and a rail mount for installation on a mounting rail of an electrical distribution system, wherein the lighting unit and the network connection unit have corresponding electrical contacts for electrical connection of the lighting unit to the network connection unit.

15. The modular lighting system of claim 14, wherein the rail mount is constructed for installation on a top hat mounting rail and/or a G-rail, and/or a C-rail.

16. The modular lighting system of claim 14, wherein the network connection unit is constructed as a plug-in socket.

17. The modular lighting system of claim 14, wherein the network connection unit has a U-shaped base body, said base body having a receptacle for receiving the lighting unit.

18. The modular lighting system of claim 14, wherein the U-shaped base body has legs, and wherein at least one guide slot is arranged in each of the legs.

19. The modular lighting system of claim 14, wherein the light source is constructed as an LED or OLED.

20. The modular lighting system of claim 14, wherein the lighting unit includes at least one energy storage device.

21. The modular lighting system of claim 20, wherein the energy storage device is constructed as accumulator.

22. The modular lighting system of claim 14, wherein the lighting unit has at least one control and/or charging electronics.

23. The modular lighting system of claim 8, wherein the control and/or charging electronics are constructed for activating the lighting unit in response to a loss of power.

24. The modular lighting system of claim 14, wherein the lighting unit has a switch constructed for activation of the light source upon removal of the lighting unit from the network connection unit.

25. The modular lighting system of claim 14, wherein the modular lighting system includes means constructed for activating the light source in response to opening a door of a distribution cabinet.

26. The modular lighting system of claim 14, wherein the lighting unit is arranged in the network connection unit and connected to the network connection by plug-in contacts and is retained in the network connection unit by a releasable latching connection.

27. The modular lighting system of claim 14, wherein the releasable latching connection is formed on the plug-in contacts.
